(19) United States
(12) Patent Application Publication
(10) Pub. No.: US 2022/0396324 A1
(43) Pub. Date: Dec. 15, 2022

(54) BICYCLE TRAINING WHEEL ASSEMBLY HAVING A HYRO-PNEUMATIC MOTION CONTROL SYSTEM

(71) Applicant: Labops, LLC, Wayne, NE (US)

(72) Inventor: John Brogie, San Antonio, TX (US)

(73) Assignee: Labops, LLC, Wayne, NE (US)

(21) Appl. No.: 17/344,913

(22) Filed: Jun. 10, 2021

(51) Int. Cl. B62H 1/12

(52) U.S. Cl. CPC B62H 1/12

(57) ABSTRACT

A training wheel assembly for a bicycle comprising a generally vertical support arm mounted to a bicycle frame, a generally horizontal support arm, pivotally mounted to the vertical support arm by a hinge joint, and a resistance gas cylinder attached to the vertical support arm and horizontal support aim to provide resistance to the pivot action of the arms.

### CROSS-REFERENCE TO RELATED APPLICATION

This application does not make a claim of priority to any application.

### BACKGROUND

### Field

One or more of the embodiments of the instant invention disclosed generally relates to a training wheel system for a bicycle.

### Description of Related Art

A conventional training wheel assembly for a bicycle comprises two support brackets mounted on two opposite sides of a bicycle frame, at or near a rear wheel assembly, comprising two training wheels, each rotatably mounted on a respective support bracket.

A bicycle training wheel system is designed to maintain a bicycle in the upright position while a novice rider learns to balance the bicycle by their own efforts. U.S. Pat. No, 4,615,535, by David K. McMertrey is an example of a conventional training wheel system for a bicycle comprises two support brackets, with fixed structural configuration, each bracket having a wheel, rotatably mounted to the bracket. It is common to mount one support bracket on each of the opposite sides of a bicycle frame, typically at or near the rear wheel axle, so positioned that each wheel may contact the riding surface. Another example, U.S. Pat No. 6,994,368 by Charles Brown describes a variation on the fixed structural configuration having a training wheel assembly that employs a series of rigid, flat, bolted metal strips.

A number of existing patents, regarding application of variable stabilizing force to maintain the bicycle upright, can be grouped into one or more of several groupings. These groups include: (1) adjustable stabilizing force accomplished through the employment of a plurality of fixed angular adjustment positions, (2) adjustable stabilizing force accomplished through the employment of a spring system, and (3) adjustment accomplished through the employment of a compressible cushion.

### SUMMARY

United States patents the employ some form of spring mechanism include:

U.S. Pat. No. 4,810,000, by Stephen R. Saunders describes a training wheel assembly that employs an adjustable dual spring system that is controlled by turning the front wheel handle bars.

U.S. Pat. No. 5,064,213, by Paul Storch describes a training wheel assembly that employs a pre-loaded spring that simultaneously acts to increase a restoring force as bicycle tilts while maintaining the training wheel contact with the ground opposite the tilt direction.

U.S. Pat. No. 5,100,163, by Larry P. Egley describes a training wheel assembly that employs a pre-loaded spring, with a threaded bolt and spring compression member. Egley describes the invention as possessing multiple stop and tension adjustment mechanisms.

U.S. Pat. No. 5,352,403, by Larry P. Egley describes a training wheel assembly that employs a pre-loaded spring, with a threaded bolt and spring compression member. Egley describes the invention as possessing a variable tension adjustment mechanisms.

U.S. Pat. No, 5,492,354, by Charles D Rainey describes a training wheel assembly that employs resiliently flexible arm, preferably a longitudinal coil spring for laterally spacing the training wheels from a rear bicycle wheel. The training wheels are shown to be flush with the bottom of the back wheel, and Rainey describes the invention as permitting assembly to bend as necessary to accommodate the rider leaning into a turn.

U.S. Pat. No. 6,318,745 by James V. Sharp describes a training wheel assembly that employs a hinged parallelogram framework including a combination chain and spring tensioning mechanism attached between opposite parallel sides. The training wheels are shown to be flush with the bottom of the back wheel, and Sharp describes the invention as permitting assembly to pivot to through an adjustable range of motion and tension resistance.

U.S. Pat. No. 6,331,012, by Al A. Eisenmann describes a training wheel assembly that employs a strut including a hollow sleeve, a spring disposed within the sleeve, and a threaded shaft for adjusting compression of the spring. The training wheels are shown to be flush with the bottom of the back wheel, and Eisenmann describes the Invention as permitting assembly to pivot to through an increasing or decreasing range of side travel and spring compression.

U.S. Pat. No. 6,705,632 by Hiroshi Yoshida describes a training wheel assembly that employs a tongue and grove hinge mechanism, an overlapping T-shaped framework, and a compression spring assembly that functions to hold the framework together and allow for bicycle incline during a turn.

U.S. Pat. No. 7,556,277 by Kimberly M. Lytle describes a training wheel assembly that employs a remotely controlled, motorized adjustment device. The training wheels are shown to be flush with the bottom of the back wheel, and Lytle describes the invention having a spring that urges the training wheels to contact the riding surface.

U.S. Pat. No. 7,641,213 by Yu-Gang Chen describes a training wheel assembly that employs a telescoping tube adjustment mechanism, with a stiffness adjusting member biased between the telescoping tubes. The training wheels are shown to be flush with the bottom of the back wheel, and Chen describes the invention utilizing a threaded adjustment member permitting assembly to pivot to through an increasing or decreasing range of upward or downward travel and spring compression.

United States patents that employ some form of compressible frame or resistance cushion mechanism include:

U.S. Pat. No. 7,226,067, by Graham William Pickering describes a training wheel assembly that employs a visco-elastic connector to produce spring force to progressively oppose angular displacement. The training wheels are shown to be flush with the bottom of the back wheel, and Pickering describes the invention as permitting assembly to move through an increasing or decreasing range of angular displacement.

U.S. Pat. No. 7,641,213 by Yu-Gang Chen describes a training wheel assembly that employs a telescoping tube adjustment mechanism, with a stiffness adjusting member biased between the telescoping tubes. The training wheels are shown to be flush with the bottom of the back wheel, and Chen describes the invention utilizing a threaded adjustment member permitting assembly to pivot to through an increasing or decreasing range of upward or downward travel and cylinder of compressible material.

U.S. Pat. No. 7,032,916 by Solvio Plana describes a training wheel assembly that employs a single piece molded structure with a C-shaped compliant hinge structure. The training wheels are shown to be flush with the bottom of the back wheel, and Plana describes the invention allowing upward angular adjustment of training wheels relative to the rear bicycle wheel.

None of the above inventions and patents, taken either singly or in combination, is seen to describe the instant invention as claimed.

### SUMMARY OF THE INVENTION

The present invention resides in providing a bicycle training wheel system with the functional resistance and restorative force attributes of a gas cylinder, applied to the problems associated with controlling the reactive movements of the bicycle training wheel assembly. Utilizing a gas loaded piston assembly (herein after “gas assembly”) in conjunction with a bicycle training wheel system employs a set of physical properties that differ markedly from the mechanical properties of a traditional metal spring training wheel system.

The gas assembly is utilized in conjunction with a hinged frame and wheel to provide controlled vertical orientation assistance when mounted to a bicycle. The gas assembly provides assistance to a bicycle rider in maintaining a bicycle in an upright orientation through application of a smooth adjustable force. The nature of the mechanism allows the rider to receive appropriate balance assistance without unduly hindering the proper bicycle motion necessary to operate the bicycle. This assembly allows the rider to smoothly lean into turns with a variety of speeds and angles to safely learn the proper balance requirements. The design is configured to adjustably fit a variety of bicycle frames and rider weights.

[symbol]

[symbol]

### BRIEF DESCRIPTION OF THE DRAWINGS

In relation to the description of the drawings, the same or similar reference numeral may be used for the same or similar constituents. The above and other aspects, features, and advantages of certain embodiments of the disclosure will be more apparent from the following detailed description, taken in conjunction with the accompanying drawings, in which:

FIG. 1 is an end view of a bicycle with the training wheel system of the present invention mounted thereon.

FIG. 2A is an exploded view of the training wheel system components and bicycle components as configured on a bicycle rear axle.

FIG. 2B is an exploded view of alternative training wheel system components and bicycle components as configured on a bicycle rear axle.

FIG. 3A is a perspective view of an isolated lower pivot arm.

FIG. 3B is a partial lower pivot arm depiction of a nut and bolt fastener for rotatably mounting a wheel to the lower pivot arm.

FIG. 3C is a partial lower pivot arm depiction of a combination threaded sleeve, incorporated into the lower pivot arm, and bolt for mounting a wheel to the lower pivot arm.

FIG. 3D is a partial lower pivot arm depiction of a polymer axle so configured to allow the training wheel to snap into place by use of a split axle configuration.

FIG. 4A is perspective view of a U-channel support arm configuration with a single axle orifice.

FIG. 4B is a perspective view of a U-channel support arm configuration with multiple axle orifices.

FIG. 5A is a perspective view of a U-channel support arm bottom side configured with a first series of ridges that cooperatively engage a second series of ridges on an axle nut spacer to prevent unwanted rotation of the training wheel assembly.

FIG. 5B is a perspective view of a U-channel support arm bottom side configured with a first series of pins that cooperatively engage a series of orifices on an axle nut spacer to prevent unwanted rotation of the training wheel assembly.

FIG. 6 is a perspective view of one side of the training wheel assembly.

FIG. 7 is a front view of the training wheel assembly.

FIG. 8 is a side view of the training wheel assembly, including a cargo tray, fastened to and between, the horizontal element of the training wheel assembly and the bicycle seat post.

### DETAILED DESCRIPTION

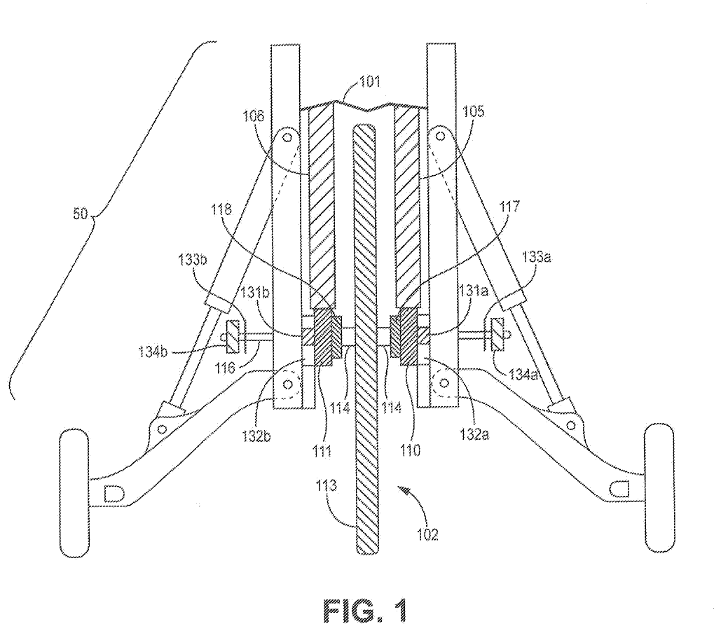

Referring to the drawings generally, the present invention is directed toward a bicycle training wheel system. As illustrated in FIGS. 1 through 8, the training wheel system may exist is one of several framework configurations. Each of the several embodiments comprise a left hand side and a right hand side training wheel assembly corresponding to the right hand side and left hand side of a rider seated upon the bicycle.

One embodiment of the current training wheel invention comprises two independent assembly sub-units. The descriptions of this first embodiment shall be directed to the right hand side elements for convenience, but are inclusive of identical mirror image left side elements.

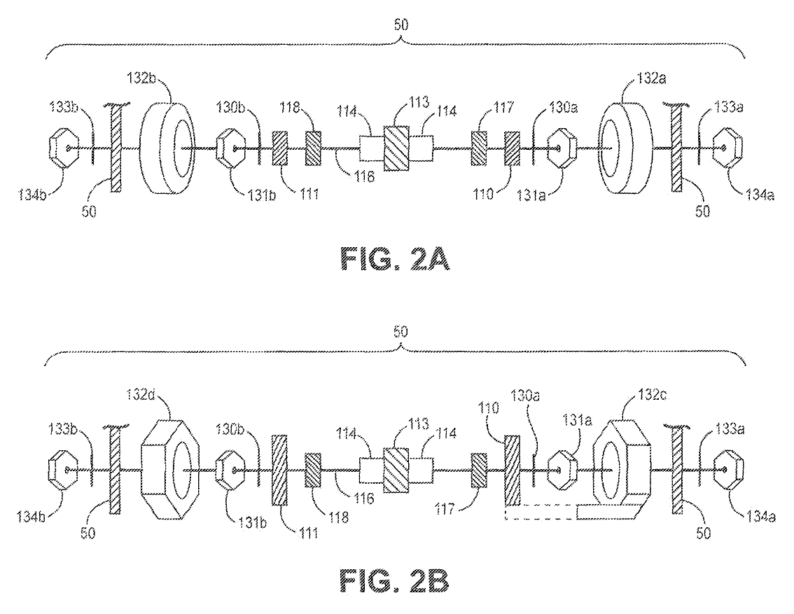

Referring to the drawings, in which identical parts are designated by the same reference numerals throughout, as shown in FIG. 1, FIG. 2A, and FIG. 2B, the present invention is directed to a bicycle training wheel system 50.

Referring to FIG. 1 a partial rear frame structure 101 and a partial rear wheel structure 102 is disclosed. The partial rear frame structure 101 comprises a right side rear fork 105, a left side rear fork 106. a right side rear fork end 110, and a left side rear fork end 111. The partial rear wheel structure 102 comprises a wheel 113 and a rear wheel hub 114 forming a rear wheel assembly 115. A threaded rear axle 116 is so configured to rotatably accept the rear wheel hub 114 in a conventional manner. The combination rear wheel hub 114 and threaded rear axle 116 is positioned between the right side rear fork end 110 and the left side rear fork end 111 utilizing a right side inner space 117 and a left side inner spacer 118 to ensure adequate clearance space between the rear hub 114 and the fork ends 110 and 111. The spacers 117 and 118 are often times a standard washer, but they may have any thickness required for appropriate spacing of the rear hub 114 and fork ends 110 and 111.

Referring to FIG. 1 and FIG. 2, each rear fork end 110 and 111 further comprises a right rear wheel axle slot (not shown) and left rear wheel axle slot (not shown) respectively. These axle slots are configured to adjustably accept the combination rear wheel hub 115, rear axle 116, inner spacer 117, and inner spacer 118, to create a mounting structure for the rear wheel structure 102 to the bicycle frame 100. The rear wheel structure 102 is removably fastened to the bicycle frame 101 with a right side axle washer 130a, a right side axle nut 131a, a left side axle washer 130b, and a left side axle nut 131b in a conventional manner.

Again referring to FIG. 1 and FIG. 2, a right side axle nut spacer 132a and a left side axle nut spacer 132b are so configured with a recess large enough to accept the treaded rear axle and axle nuts 131a and 131b. FIG. 2A discloses the axle nut spacer 132a and 132b as a circular configuration. FIG. 2B discloses axle nut spacers 132d may have an octagonal configuration or axle nut spacer 132e may have an octagonal configuration with a locking tab. The locking tab cooperatively interacts with the bicycle frame 110 to prevent unwanted rotation of the bicycle training wheel system 50 around the rear wheel axle 116. These disclosed configurations are not exhaustive of all the possible shapes and configuration. The mounting spacers 132a and 132b provide a means for mounting the training wheel assembly 50 without altering the standard rear wheel hub fastening structure. It is understood, the invention anticipates the mounting spacers 132a and 132b may be of any size and shape that works cooperatively, without interference with the bicycle frame configuration. Further, the mounting spacers 132c and 132d exemplify additional possible configurations, octagonal shape and locking tab that prevents the training wheel system from unwanted rotation about the rear wheel axle while in use. The training wheel assembly 50 is so configured to accept the threaded rear wheel axle and allow removable fastening with a right side assembly washer 133a, a right side assembly nut 134a, a left side assembly washer 133b, and a left side assembly nut 134b. The training wheel assembly 50 may be attached and removed from the bicycle without removal of axle nuts 131a or 131b.

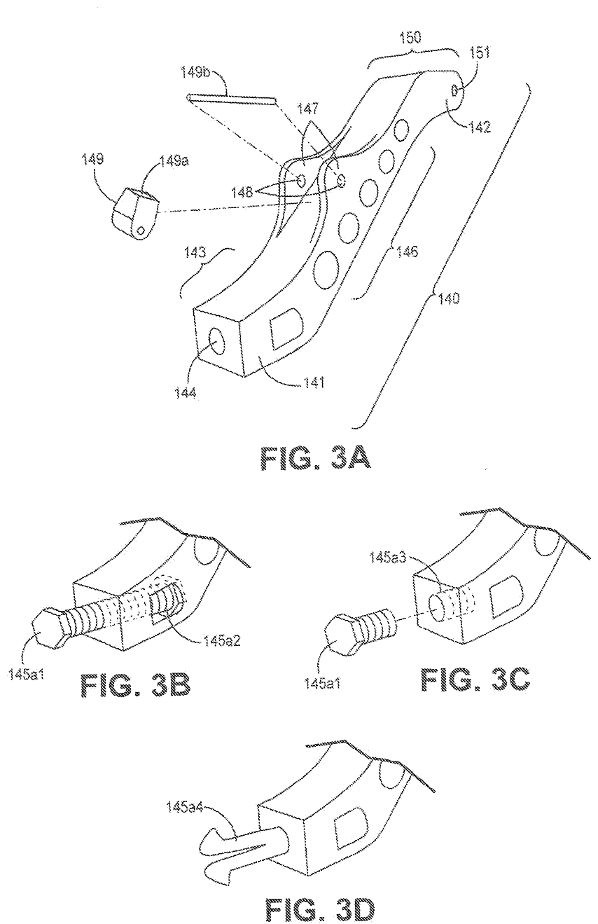

Referring to FIG. 3A, one embodiment of the training wheel system 50 comprises a lower pivot arm, generally designated by the reference number 140. The lower pivot arm 140 comprises a proximal end, generally designated by the reference number 141. The lower pivot arm 140 comprises a distal end, generally designated by the reference number 142. The lower pivot arm proximal end 141 further comprises a training wheel mounting region, generally designated 143. The training wheel mounting region 143 comprises a training wheel axle orifice, generally designated 144, and so configured to accept a training wheel axle, generally designated 145, for rotatably receiving a wheel. The training wheel axle 145 configuration may comprise any configuration that provides a shaft upon which a wheel may rotate and attach to the lower pivot arm. The FIG. 3B discloses a standard nut and bolt configuration for the training wheel axle 145, comprising a bolt 145a1 and a nut 145a2, but is inclusive of any known method for attaching a rotatable wheel. For example, the FIG. 3C discloses the training wheel axle 145 comprises the bolt 145a1 and a threaded metal sleeve 145a3, molded directly into the proximal end of the lower pivot arm 140. Another example, the FIG. 3D discloses an axle need not be a threaded bolt, but may comprise a polymer axle 145a4, so configured to allow the training wheel to snap into place by use of a split axle configuration. These examples are not inclusive of all possible configurations. The current invention is inclusive of all possible known configurations for rotatably attaching a wheel to the lower pivot arm 140.

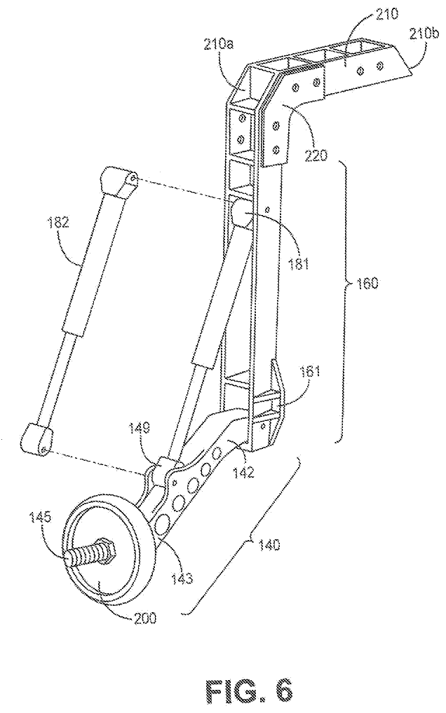

The lower pivot arm 140 further comprises a first gas spring mounting region, generally designated by the reference number 146. The first gas spring mounting region comprises a pair of first gas spring mounting flanges, generally designated by the reference number 147. Each of the first gas spring mounting flanges 147 comprises a first gas spring mounting orifice, generally designated by the reference number 148. The lower pivot arm 140 further comprises a first pivot gas spring mounting bracket, generally designated by the reference number 149, and pivotally positioned between the first gas spring mounting flanges 147. The first pivot gas spring mounting bracket 149, further comprises a first threaded metal female grommet, generally designated by'the reference number 149a, and configured to accept male threading of a gas spring, generally designated by the reference number 182 (shown in FIG. 6). The lower pivot arm 140 further comprises a first lower pivot arm, gas spring mounting pin 149b that acts as an axle for the gas spring 182.

The lower pivot arm distal end 142 further comprises a first hinge mounting region, generally designated by the reference number 150. The first hinge mounting region 150, comprises a pivot arm first hinge mounting orifice, generally designated by the reference number 151.

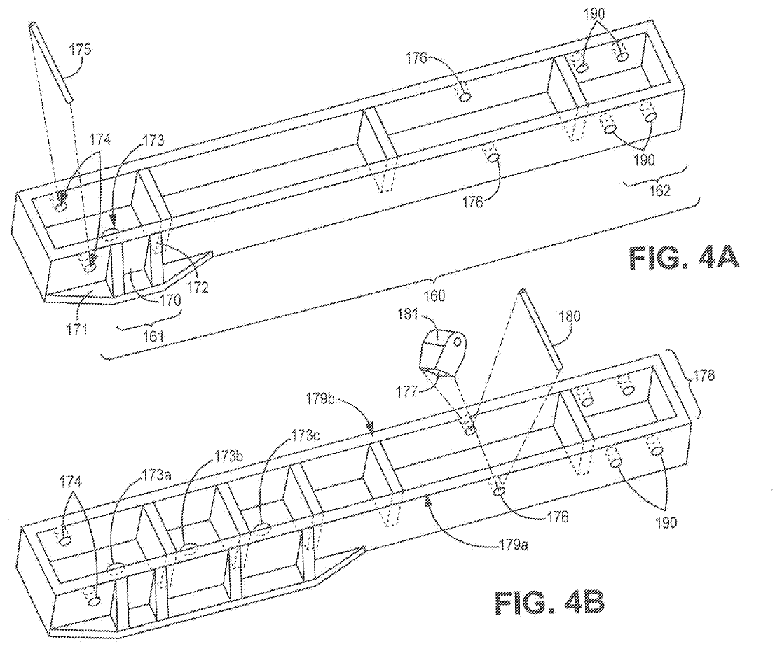

As seen in FIG. 4, the training wheel system 50 comprises a U-channel support arm, generally designated by the reference number 160. The support arm 160 comprises a proximal end, generally designated by the reference number 161, and a distal end, generally designated by the reference number 162.

Again referring to FIG. 4, the U-channel support arm 160 possesses a reinforced mounting region, generally designated by the reference number 170 at or near the proximal end 161. The mounting region 170 comprises a reinforced mounting plate, generally designated by the reference number 171. The depicted reinforced mounting plate 171 possesses one or more support braces, generally designated by the reference number 172. This series of braces represents one of several possible configuration that one skilled in the art would apply to increase the support arm 160 strength in the mounting region 170.

The mounting region 170 comprises an axle orifice, generally designated by the reference number 173 and so configured to accept the rear wheel axle 116 to reversibly attach the support arm 160 to the bicycle rear frame 101 as shown in FIG. 1.

As shown in FIG. 4B, the mounting region 170 may possess one or more rear wheel axle 116 orifices (173a, 173b, and 173c) for training wheel system adjustments to accommodate a variety of bicycle sizes. The axle orifice 173 may also be reinforced with a metal grommet to increase orifice strength.

The proximal end of support arm 60 comprises a pair of support arm first hinge mounting orifices, generally designated by reference number 174. The support arm first hinge mounting orifices 174, so configured to accept a pivot arm first hinge pin 175. The combination of support arm first hinge mounting orifices 174 is configured to cooperatively and pivotally accept the first hinge mounting region 150. The pivot arm first hinge mounting orifice 151 is configured to rotatably accept pivot arm first hinge pin 175 to form a hinge between support arm 160 and the lower pivot arm 140 as shown in FIGS. 1, 6, and 7.

Again referring to FIG. 4, the U-channel support arm 160 possesses a pair of support unit second gas spring mounting orifices, generally designated by the reference number 176. The support arm first pivot mounting orifices 176 are so configured to cooperatively accept a second pivot gas spring mounting bracket, generally designated by the reference number 181.

The second pivot gas spring mounting bracket 181 is positioned within a U-channel, generally designated by the reference number 178. The U-channel 178 is formed by U-channel support arm sides, generally designated by the reference numbers 179a and 179b.

The second pivot gas spring mounting bracket 181 is positioned between the support arm first pivot mounting orifices 176, so as to pivotally accept a first pivot mounting pin, generally designated by the reference number 180. The second pivot gas spring mounting bracket 177, further comprises a second threaded metal female grommet, generally designated by the reference number 177, and configured to accept a male threaded gas spring, generally designated by the reference number 182 and shown in FIG. 6.

Again referring to the distal end 162 of the U-channel support arm 160, comprises a series of gusset mounting orifices, generally designated by the reference number 190. The gusset mounting orifices 190 are configured so as to accept fasteners, such as bolts, screws, rivets, or arty other fastening element that will hold the training wheel frame elements together. The gusset mounting orifices may be circular or slots. The slot shape may be selected to accommodate small modification or adjustments for bicycle sizes.

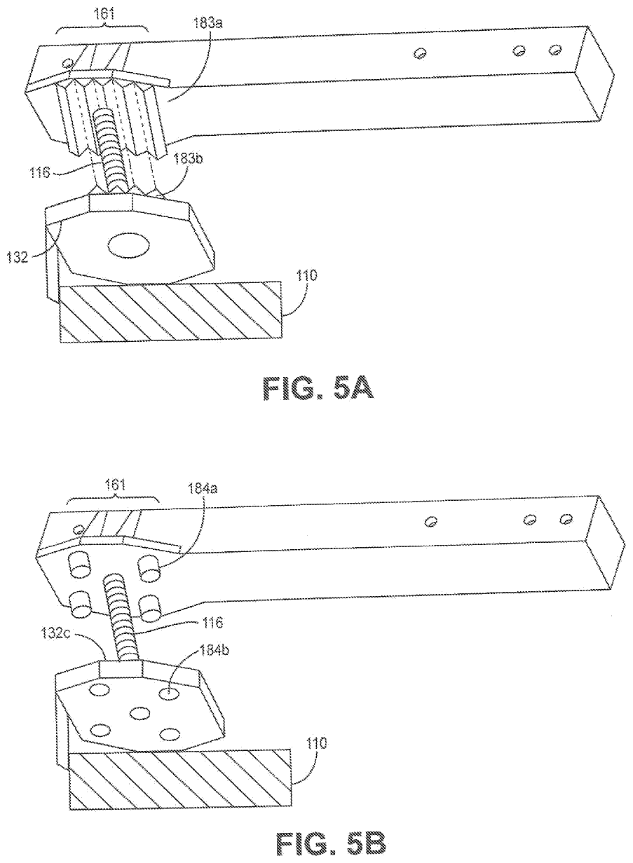

As shown in FIG. 5, the U-channel support arm 160 possesses a bottom side, opposite the U of the channel. The bottom of the U-channel support arm 160, in the reinforced mounting region 170, at or near the proximal end 161, further contains elements that prevent unwanted rotation of the training wheel system 50.

FIG. 5a, depicts an embodiment comprising a series of teeth, generally designated by the reference number 183a, on or near the proximal end 161 of the bottom side of the U-channel support arm 160. The teeth 183a cooperatively engage a set of teeth, generally designated by the reference number 183b, on the axle nut spacer 132. As described previously, the axle nut spacer 132 may have a variety of shapes and configurations (i.e., 132a-132d as shown in FIG. 2).

Another embodiment found in FIG. 5b, comprises a series of pins, generally designated by the reference number 184a, on or near the proximal end 161 of the bottom side of the U-channel support arm 160. The pins 184a cooperatively engage a set of recesses, generally designated by the reference number 184b, in the axle nut spacer 132.

These are but two of the possible configurations for preventing the unwanted rotation of training wheel system 50, and it is understood that many other possible modifications and variations can be made without departing from the scope of the present invention as explained.

As seen in FIG. 6, the training wheel system 50 comprises a training wheel, generally designated by the reference number 200, rotatably mounted to the lower pivot arm 140, at or near the training wheel mounting region 143, utilizing the training wheel axle 145. The lower pivot arm 140 having the distal end 142 is pivotally mounted on the U-channel support arm proximal end 161. A gas spring, generally designated by the reference number 182, is mounted between the first pivot gas spring mounting bracket 149 and second pivot gas spring mounting bracket 181.

The training wheel system 50 comprises a horizontal support member, generally designated by the reference number 210. The horizontal support member 210 connects the right and left side training wheel system 50 components, as seen in FIG. The horizontal support member 210 possesses a horizontal support member first end, generally designated by the reference number 210a and a horizontal support member second end, generally designated by the reference number 210b. A reinforcement gusset, generally designated by the reference number 220, is employed at the joint between the U-channel support arm distal end 162 and the horizontal support member first end 210a to fasten the parts together.

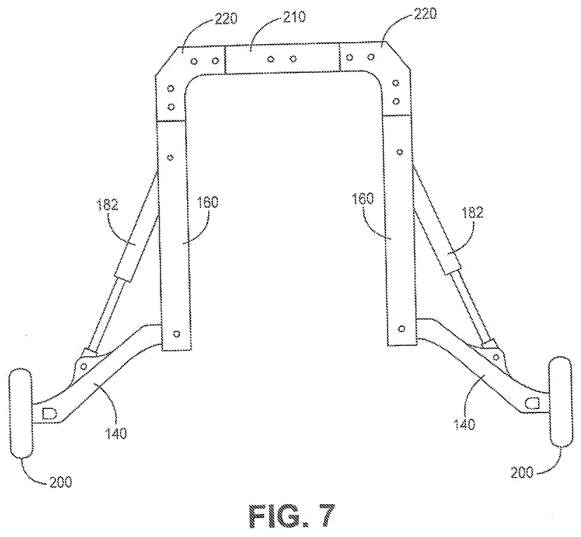

FIG. 7 depicts a front view of one alternative configuration for the training wheel system 50. FIG. 7 depicts a single unit training wheel system, configured to connect the right hand side of the training wheel system 50 with the left hand side of training wheel system 50. One possible benefit of connecting the right and left units of the training wheel system 50, is to add rigidity and stability to the system.

It is understood that many other possible modifications and variations can be made without departing from the scope of the present invention as explained.

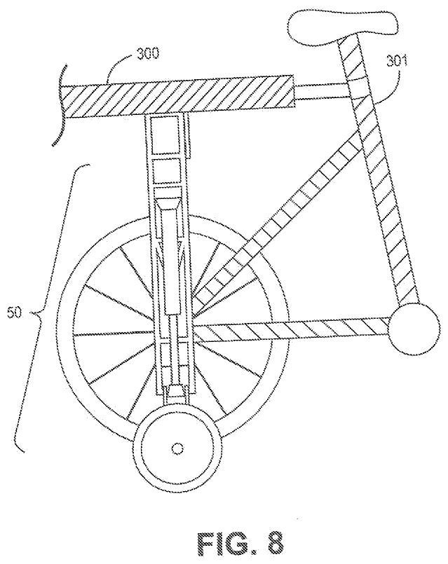

FIG. 8 depicts another configuration that is understood to be a possible modification that is within the scope of the present invention. FIG. 8 depicts the addition of a cargo tray, generally designated by the reference number 300, attached to the horizontal support member 210 of the training wheel system 50, and additionally attached to the bicycle framework, generally designated by the reference number 301.

It is understood that a possible modification that falls within the scope of this invention would include modifying the cargo tray 300 to attach directly to the generally vertical support arms 160 to function as both the cargo tray 300 and the horizontal support member 210.

What is claimed is:

1. A training wheel system for a bicycle, comprising:
a support arm attached at or near a bicycle rear wheel axle, the support arm pivotally connected to a lower pivot arm, forming a hinge, and a gas spring disposed between the support arm and lower pivot arm to control the pivotal movement of the hinge.
